(19) United States
(12) Patent Application Publication
(10) Pub. No.: US 2026/0088393 A1
(43) Pub. Date: Mar. 26, 2026

(54) COOLANT MANIFOLD FOR BATTERY PACK

(71) Applicant: PROTERRA POWERED, LLC, Burlingame, CA (US)

(72) Inventors: DUYBAO DAO, Burlingame, CA (US); DUSTIN GRACE, Burlingame, CA (US); DEREK PAUL

(73) Assignee: PROTERRA POWERED, LLC, Burlingame, CA (US)

(21) Appl. No.: 19/109,654

(22) PCT Filed: Sep. 15, 2023
(86) PCT No.: PCT/US23/74368

§ 371 Date: Mar. 7, 2025

Related U.S. Application Data
(60) Provisional application No. 63/376,091, filed on Sep. 18, 2022.

(51) Int. Cl. H01M 10/6556; H01M 10/613; H01M 10/625; H01M 10/6568; H01M 50/204; H01M 50/289

(52) U.S. Cl. CPC H01M 10/6556; H01M 10/613; H01M 10/625; H01M 10/6568; H01M 50/204; H01M 50/289

(57) ABSTRACT

A battery pack including a plurality of battery modules, each battery module including a plurality of battery cells, a coolant inlet, and a coolant outlet; a coolant manifold plate for supplying and return coolant to and from the battery modules, the coolant manifold plate including: a wall of the battery pack; a vertical coolant rail; a plurality of horizontal coolant rails, wherein the plurality of horizontal rails are parallel with one another and perpendicular to the vertical rail, the vertical coolant rail supplies coolant to each of the plurality of horizontal coolant rails, and the manifold plate supports each battery module.

### TECHNICAL FIELD

The present disclosure generally relates to battery packs, and more particularly to coolant manifolds for battery packs.

### BACKGROUND

Battery packs can be bulky and may therefore be challenging to incorporate as a power source in many applications. For example, electric vehicle designers may by constrained by an overall size of the vehicle and may therefore have difficulty dedicating space to very large battery packs suitable to meet the power demands of the vehicle. Additionally, battery packs may be shaped in such a way that when multiple battery packs are needed for an application, clustering the battery packs together in a centralized, bulky battery system may be virtually unavoidable. Such clustering can lead to difficulties removing heat generated by the battery packs. Moreover, battery packs and battery systems may include intricate circuitry and wiring, making it difficult to port the system to provide efficient cooling with a coolant.

Further, batteries can generate significant heat during electrical discharge. Certain battery packs can require relatively high discharge rates when operating, which discharge rates can generate relatively large quantities of waste heat, which must be removed from the battery pack. Meanwhile, battery packs should have a form factor that is convenient for integration with other systems, a minimal weight, and provide as much electrical power as possible.

Current cooling systems are not optimized to meet such requirements. Current cooling systems may circulate coolant in coolant supply and return channels external to a battery pack's housing, which may expel some valuable cooling effect to an environment rather than capturing the maximum cooling effect possible with internal cooling channels. Moreover, battery pack housing with external cooling supply and return channels may not optimize battery pack form factors for maximal power supply to an electric vehicle.

The systems and methods of the present disclosure may solve one or more of the problems set forth above and/or other problems in the art. The scope of the current disclosure, however, is defined by the attached claims, and not by the ability to solve any specific problem.

### SUMMARY

In one aspect, a battery pack includes a plurality of battery modules, each battery module including a plurality of battery cells, a coolant inlet, and a coolant outlet; a coolant manifold plate for supplying and return coolant to and from the battery modules, the coolant manifold plate including: a wall of the battery pack; a vertical coolant rail; a plurality of horizontal coolant rails, wherein the plurality of horizontal rails are parallel with one another and perpendicular to the vertical rail, the vertical coolant rail supplies coolant to each of the plurality of horizontal coolant rails, and the manifold plate supports each battery module.

In another aspect, a battery pack includes a plurality of battery modules, each battery module including a plurality of battery cells, a coolant inlet, and a coolant outlet; a coolant manifold plate for supplying and return coolant to and from the battery modules, the coolant manifold plate including: a wall of the battery pack having a plurality of rail-receiving grooves; a vertical coolant rail having a vertical coolant supply conduit and a vertical coolant return conduit; a plurality of horizontal coolant rails, wherein the plurality of horizontal rails are parallel with one another, perpendicular to the vertical rail and received in the rail-receiving grooves of the wall of the battery pack; wherein the vertical coolant rail supplies coolant to each of the plurality of horizontal coolant rails.

In yet another aspect, a battery pack includes a plurality of battery modules arranged in a plurality of rows and columns, each battery module including a cooling plate, a plurality of battery cells, a coolant inlet, and a coolant outlet; a coolant manifold plate for supplying and return coolant to and from the battery modules, the coolant manifold plate including: a wall of the battery pack having a plurality of rail-receiving grooves; a vertical coolant rail having a vertical coolant supply conduit and a vertical coolant return conduit; a plurality of horizontal coolant rails, wherein the plurality of horizontal rails are parallel with one another, perpendicular to the vertical rail and received in the rail-receiving grooves of the wall of the battery pack; and a plurality of inserts located between the horizontal coolant rails and rail-receiving grooves of the wall of the battery pack, the inserts are formed of one of a foam, silicone, and/or rubber; and wherein the vertical coolant rail supplies coolant to each of the plurality of horizontal coolant rails.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts an exemplary battery pack and cooling system with a portion of a top cover of the battery pack removed.

FIG. 2 depicts details of the interior of the battery pack of FIG. 1.

FIG. 3 depicts an exterior view of a cooling manifold of the battery pack of FIG. 1.

FIG. 4 depicts an interior view of the cooling manifold of the battery pack of FIG. 1.

FIG. 5 depicts the interior view of the cooling manifold of FIG. 4 in an exploded view.

FIG. 6A depicts a vertical cross sectional view of the cooling manifold plate at section 6A-6A of FIG. 4.

FIG. 6B depicts vertical cross sectional view of the cooling manifold plate as section 6B-6B of FIG. 4.

FIG. 7 depicts a portion of the cooling manifold of FIG. 4 with a portion of a vertical supply rail removed.

FIG. 8 depicts a sealing side of a vertical rail of the cooling manifold of FIG. 4.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

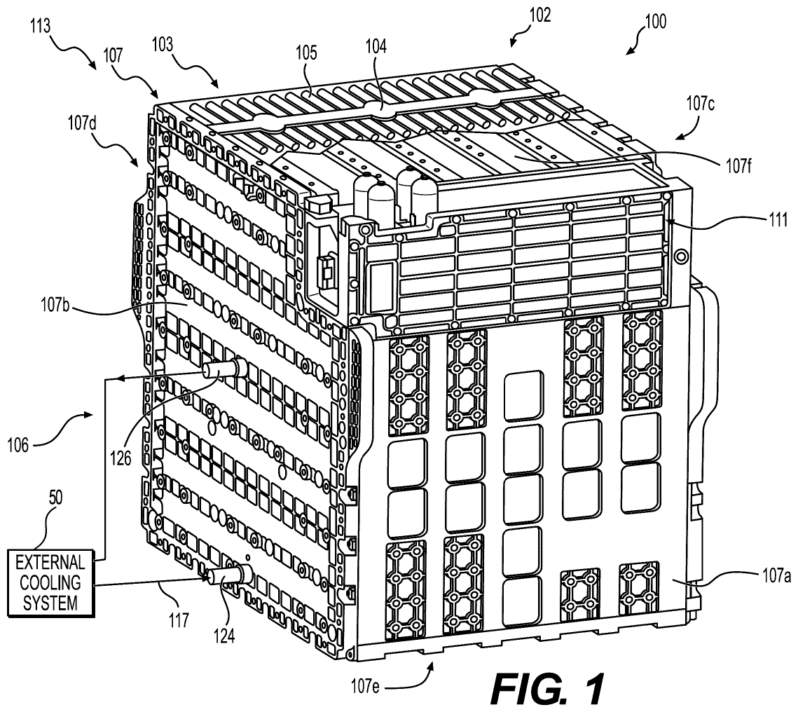

FIG. 1 shows a battery pack and cooling system 100 including an external cooling system 50 and a battery pack 102. The external cooling system 50 can be any type of cooling system for providing coolant to the battery pack 102, and receiving cooling fluid from the battery pack 102, so as to control the temperature of battery pack 102. As used herein, coolant can be any type of fluid (liquid and/or gas) that can act as a cooling agent. Examples of coolant include water, antifreeze, air, etc. The battery pack and cooling system 100 may be used in an all-electric or partially electric vehicle, such as an electric truck, electric bus, or electric automobile (not shown). However, it is understood that the battery pack and cooling system 100 could be used in any type of system that can receive stored electrical energy. While one battery pack 102 is show in FIG. 1, multiple battery packs 102 could be connected together serially or in parallel to provide power, and the multiple battery packs 102 could be connected to the same or different cooling systems 50.

Still referring to FIG. 1, the battery pack 102 includes a housing 113 forming a generally cube-like shape. While the battery pack 102 is depicted in a cube-like shape, it is understood that the battery pack 102 could be of a different shape, such a different rectangular shape, or a shape with obtuse or acute angled walls. The battery pack housing 113 may be formed by multiple walls 107, such as front wall 107a, rear wall 107d, side walls 107b, 107c, top wall 107f, and bottom wall 107e. The walls of housing 113 may be formed of, for example, die cast aluminum or any other appropriate metal or material.

Still referring to FIG. 1, battery pack 102 is shown with part of the top wall 107f removed. The interior of battery pack 102 may include a plurality of battery modules 103. Battery modules 103 may include, among other things, a cooling plate 104 and a plurality of battery cells 105. Battery cells 105 may be, for example, cylindrical and rechargeable lithium-ion cells, however other types of battery cells may be used. Cells 105 may be arranged in module 103 to abut and extend perpendicular from the cooling plate 104, on each side of cooling plate 104.

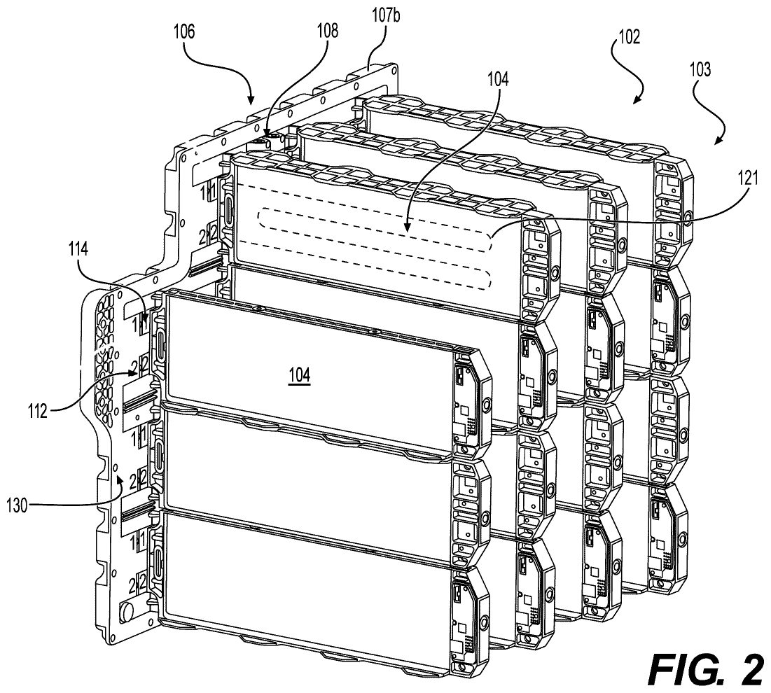

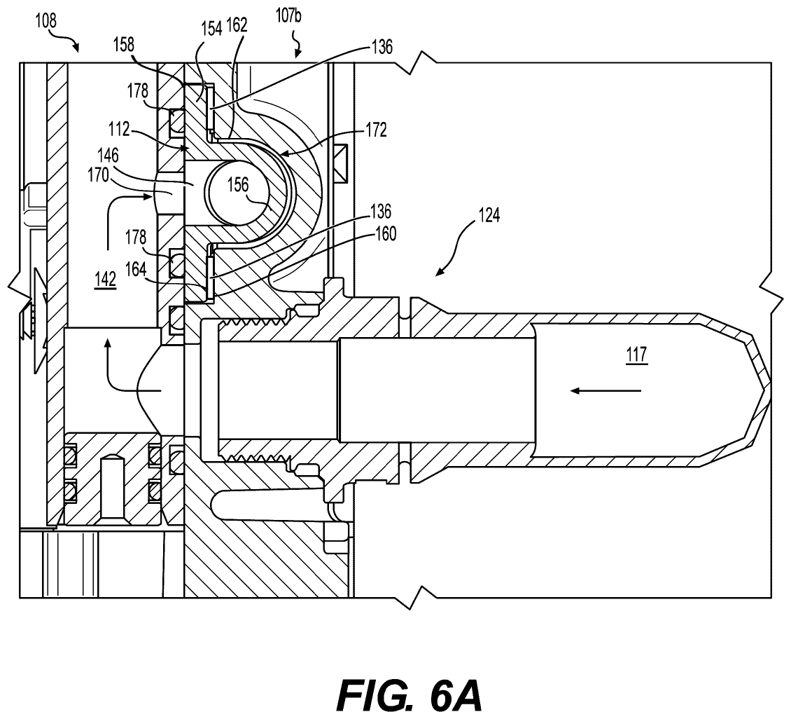

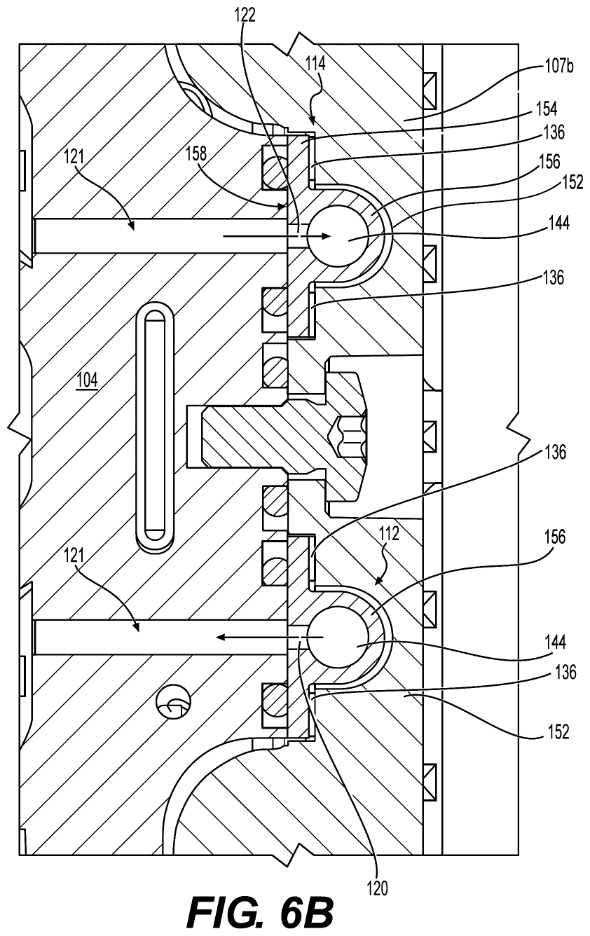

As best shown in FIGS. 1 and 2, battery pack 102 may include a plurality of battery modules 103 arranged in a series of rows and columns. For example, as shown in FIG. 2 (where the battery cells 105 and other features of the battery modules 103 and interior or the battery pack 102 are removed), four columns and four rows of cooling plates 115 are provided, corresponding to fifteen battery modules 103. The number of rows and columns of battery modules 103 inside battery pack 102 may be more or less than that shown in FIG. 2. The battery modules 103 may be fixedly connected in battery pack 102 by the cooling plates 104 being secured to side wall 107b. FIG. 6B provides a cross-sectional view of the coupling of a cooling plate 104 to side wall 107b. Cooling plates 104 (and battery modules 103) extend perpendicular from an internal surface 130 of side wall 107b. Battery pack 102 may also include electronics 111 for sensing and controlling various aspects of battery pack 102.

Referring to FIGS. 1-4, one of the walls 107 of the housing 113 of battery pack 102 may form a coolant manifold 106 of the battery pack 102. In the battery pack 102 shown in the figures, side wall 107b forms the coolant manifold 106, however other walls than side wall 107b may form the coolant manifold 106 for battery pack 102. Coolant manifold 106 may include a coolant inlet 124, a coolant outlet 126, a vertical coolant rail 108, and a plurality of horizontal coolant rails 112, 114. These combination of elements may be referred to a coolant manifold 106, or a coolant manifold plate because the assembly of elements when secured together form a generally planar or flat plate-like structure. As best shown in FIG. 2, cooling plates 104 are fixedly connected to coolant manifold 106 (via side wall 107b) so as to be fluidly connected to horizontal rails 112, 114.

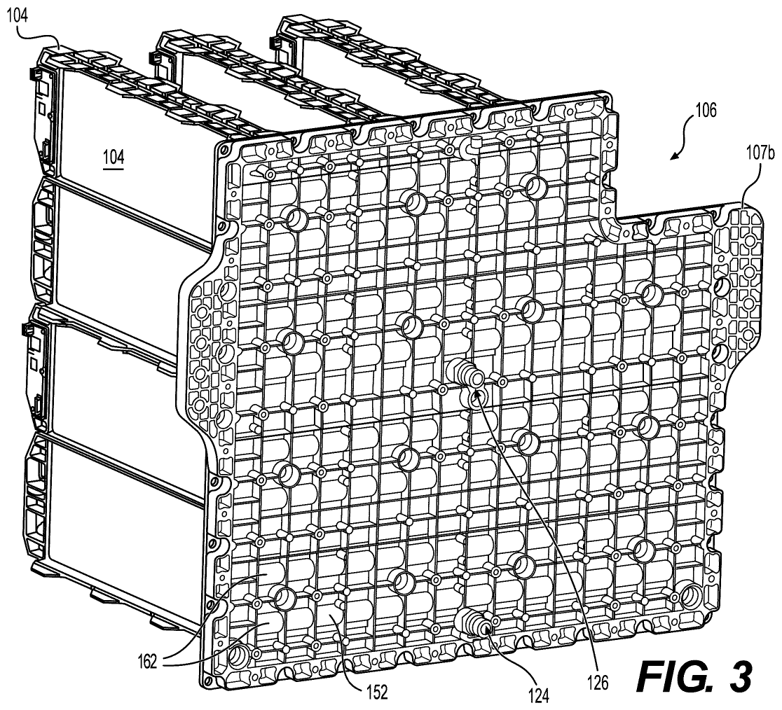

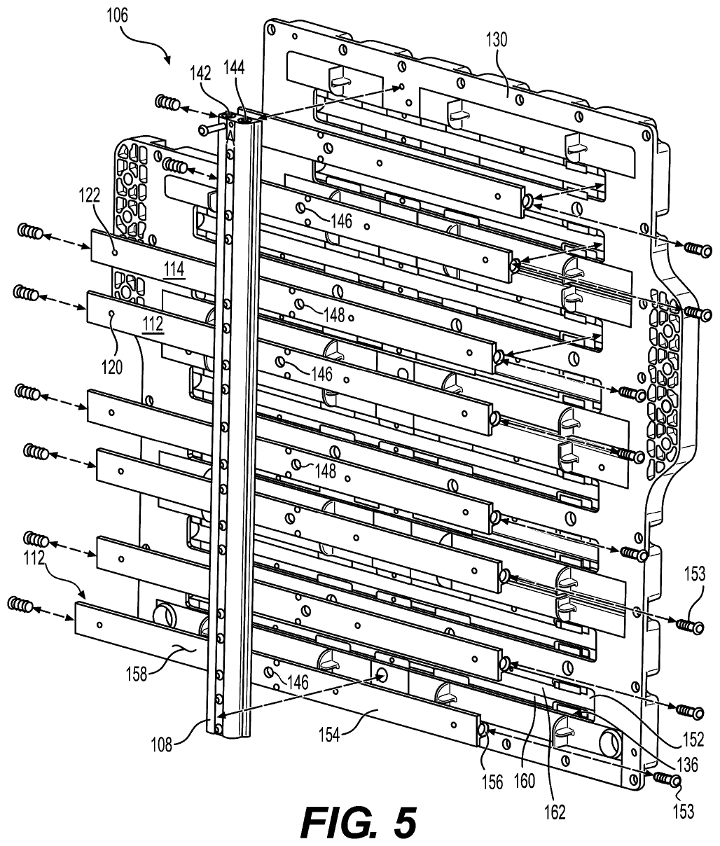

Referring to FIGS. 2-5 the vertical rail 108 may include a vertical supply conduit 142 and a vertical return conduit 144. The vertical supply conduit 142 and the vertical return conduit 144 can have any shape (e.g., a cylindrical tube, a square tube, etc.) The vertical supply conduit 142 may receive coolant from the external cooling system 50 (FIG. 1) through coolant inlet 124 (FIG. 3), and a vertical return conduit 144 may return coolant to the external cooling system 50 through coolant outlet 126 (FIG. 3). The coolant inlet 124 and the coolant outlet 126 are shown near the bottom and near the middle (vertically) of the coolant manifold 106 in the particular embodiment shown, but they could be at any point on the vertical rail 108 as necessary for a particular configuration. The vertical supply conduit 142 and the vertical return conduit 144 are fluidly coupled to the horizontal rails 112, 114 to supply coolant through a plurality of supply holes 146 (FIG. 5) in the horizontal rails 112, and to receive coolant through a plurality of return holes 148 (FIG. 5) in the horizontal rails 114. The horizontal rails 112, 114 may include a plurality of horizontal supply rails 112 and a plurality of horizontal return rails 114. Horizontal supply and return rails 112, 114 may be identical or substantially identical. Each horizontal supply rail 112 may include a plurality of supply holes 120 and each horizontal return rail 114 may include a plurality of return holes 122. The supply holes 120 and the return holes 122 may fluidly couple the internal channels of the coolant manifold 106 with the internal channels 121 of the cooling plates 104 to supply coolant to the cooling plates 104 such that coolant circulates through the cooling plates 104 to remove heat from the cells 105.

Referring to FIGS. 5, 6A, 6B, and 7, each horizontal rail 112, 114 may be received in a groove 152 in the internal surface 130 of side wall 107b. The rail-receiving grooves 152 may include a planar outer edge portion 160 and a rounded central portion 162. The rounded central portion 162 may include a half-circle shape as shown in FIGS. 6A and 6B, or could take other shapes, curved or otherwise.

The horizontal rails 112, 114 may include a planar base portion 154 and a tube portion 156. The planar base portion 154 may include a planar or flat outer surface 158 on one side of horizontal rails 112, 114 and a pair of parallel planer inner surfaces 164 on opposite sides of tube portion 156. When the horizontal rail is attached to side wall 107b, the flat outer surface 158 may be substantially flush and/or substantially parallel with the interior surface 130 of the side wall 107b. The ends of tube portion 156 may be fluidly sealed with plugs 153.

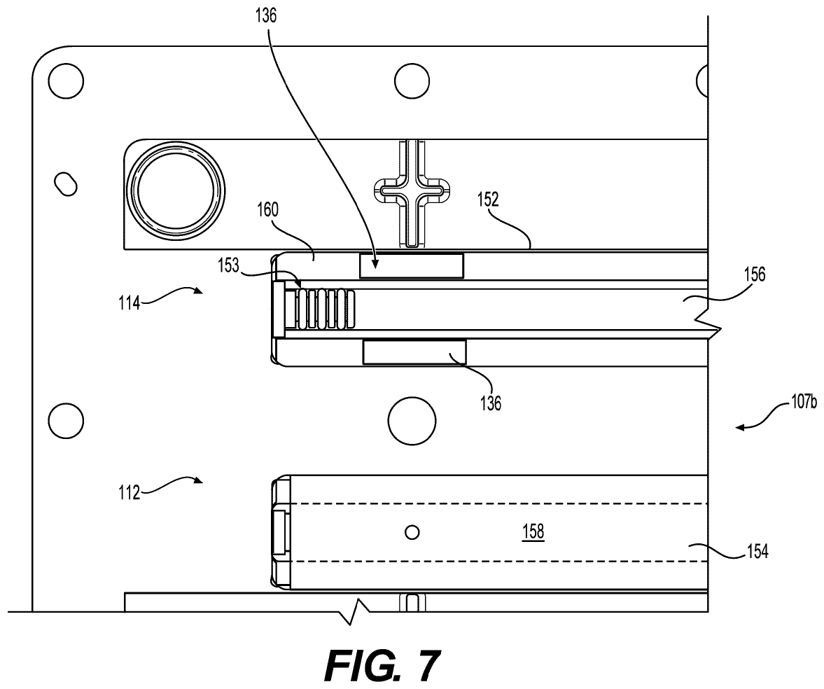

Referring to FIGS. 5 and 7, a plurality of inserts 136 may be positioned between the horizontal rails 112, 114 and the grooves 152 in side wall 107b. In particular the inserts 136 may be positioned between the planar outer edge portion 160 of grooves 152 and the planar inner surfaces 164 of horizontal rails 112, 114. The inserts 136 form a small gap between groove 152 and a respective horizontal rail 112, 114.

The inserts may be of any appropriate shape, such as a rectangular shape, and may be positioned on opposite sides of grooves 152, and in a plurality of spaced positions along the length of rail-receiving grooves 152. For example, inserts 136 may be positioned to align with each supply hole 120 or return hole 122 in the horizontal rails 112, 114. Inserts 136 may be formed of a material with an elastic or deformable property (e.g., foam, silicone, rubber, etc.). The plurality of inserts 136 may allow for manufacturing tolerance buildups or deviations, and may dampen relative motion between the horizontal rails 112, 114 and the side wall 107b. Further, the plurality of inserts 136 may serve as a thermal barrier between horizontal rails 112, 114 and the side wall 107b.

It is understood that the various components of coolant manifold may be secured together in any appropriate manner such as by fasteners or adhesion, such as screws or welding. For example, screws may be used to (1) secure the horizontal rails 112, 114 within the rail-receiving grooves 152 of side wall 107b, (2) secure the vertical rail 108 to the side wall 107b, and (3) secure the cooling plate 104 to the side wall 107b.

FIG. 6A shows a cross sectional view including the coolant supply conduit 142 of vertical rail 108 which is configured to receive coolant 117 from the external cooling system 50 through the coolant inlet 124. The coolant flows horizontally into the vertical coolant supply conduit 142 of vertical rail 108 wherein it is provided to the multiple coolant supply ports 146 along the length of the coolant supply conduit 142. The number of coolant supply ports 146 is based on the number of horizontal supply rails 112 that are desired for any particular form factor battery pack 102. The coolant flows through the coolant supply ports 146 into the tube portions 156 of horizontal rails 112. The coolant flows horizontally inside the tube portions 156 until it is supplied to one of the cooling plates 104 via supply holes 120.

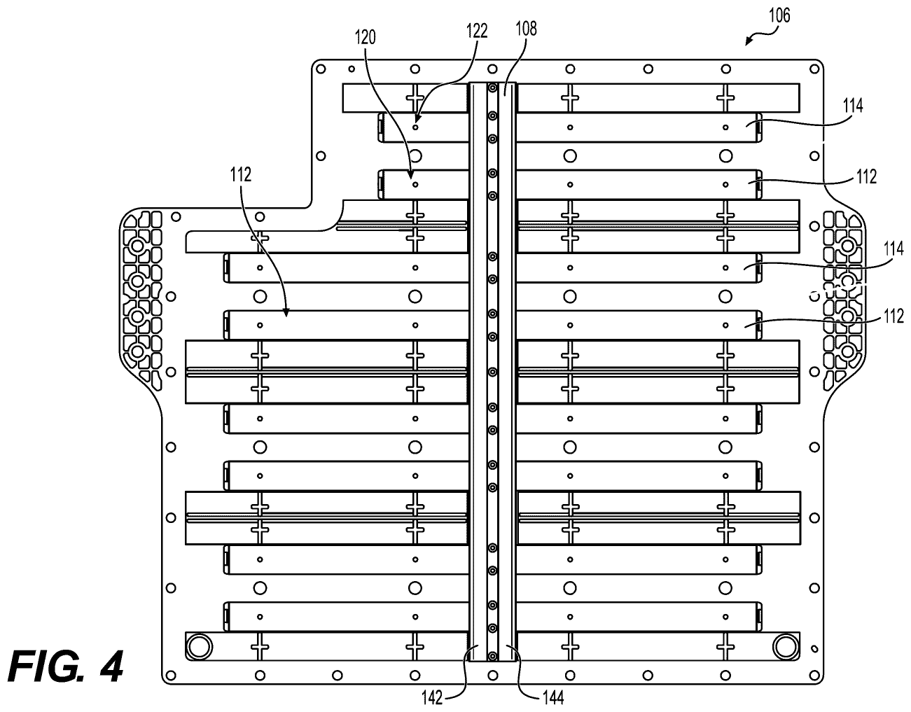

FIG. 6B shows a cross sectional view including a cooling plate 104, the horizontal supply rail 112 and the horizontal return rail 114. The coolant (depicted by schematic arrows) flows out of the tube portion 156 in the horizontal supply rail 112 and into internal cooling channel 121 of the cooling plate 104. The coolant provides cooling to the cells 105 that are thermally coupled to the cooling plates 104 and then returns to the horizontal return rail 114. The internal cooling channels 121 of cooling plate 104 may be circuitous to provide a plurality of passes of the coolant along the cooling plates 104. Once the coolant has returned to the tube portion 156 in the horizontal return rail 114, the coolant may pass to the vertical coolant return conduit 144 (FIG. 4) and may pass out of from the coolant manifold 106 (FIG. 4) through the coolant outlet 126 (FIG. 1) to the external cooling system 50.

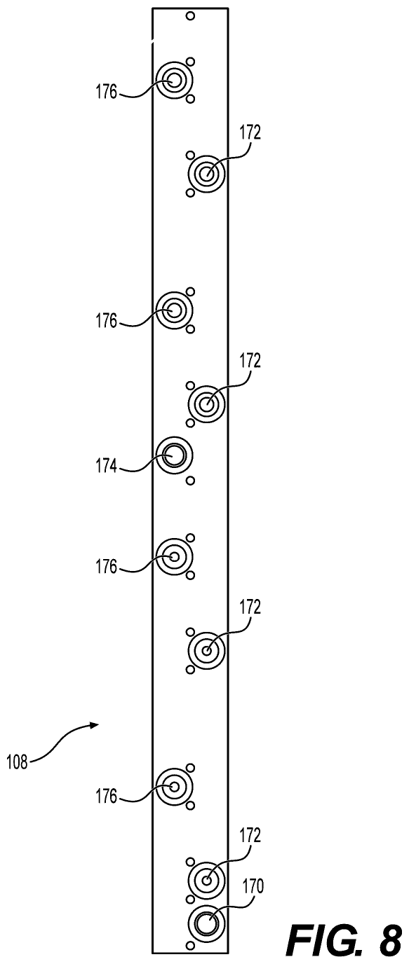

Referring now to FIG. 8, aspects of the vertical rail 108 are shown in greater detail. In particular, FIG. 8 shows an internal side surface of vertical rail 108 that mates with side wall 107b. Vertical rail 108 includes inlet 170 in fluid communication with coolant inlet 124 of side wall 107b. Inlet 170 may be fluidly coupled along inlet conduit 142 with multiple vertical supply ports 172 that fluidly connect with coolant supply ports 146 of horizontal supply rail 112. Vertical rail 108 may also include an outlet 174 fluidly connected to coolant outlet 126 of side wall 107b. Outlet 174 may be fluidly connected and receive coolant from horizontal return rail 114 via coolant return ports 148 of the horizontal return rail 114. The inlet 170, outlet 174, supply ports 172 and return ports 176 of the vertical rail 108 may each include an outer groove or recess for receiving an O-ring 178 or other type of fluid sealing member. See FIG. 6A for a depiction of the O-rings 178. Also, one or more of the inlet 170, outlet 174, supply ports 172 and return ports 176 of the vertical rail 108 may be sized or resized to provide a desired flow through coolant manifold 106. In particular, this “tuning” of the openings in the vertical rail 108 may provide for different sized openings or ports that allow for the optimization of flow to different levels of the cooling plates 104 and modules 103. That is, if a particular level in the cooling plate stack (e.g., the highest level, a center level, etc.) requires a higher coolant flow to remove a larger quantity of heat, the size/diameter of the respective inlet or outlets 170, 174, or port 172, 176 can be increased to optimize flow.

The battery pack 102 of the current disclosure may provide for ease of manufacture by limiting the amount of drilling or finishing required to side wall 107b, and limiting the number of connectors required. Further, as noted above, the inserts 136 may provide for a thermal barrier or thermal gap between the horizontal rails 112, 114 and the wall 107b of the battery pack 102, thereby reducing the heating of components outside the battery pack. Further, the deformation of inserts 136 may help compensate for misalignments between, for example, the horizontal rails 112, 114 and the wall 107b. Finally, the tuning of the inlet, outlet, and ports of the vertical rail 108 can help to provide a simple way to adjust coolant flow through the battery pack 102.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

We claim:

1. A battery pack comprising:
a plurality of battery modules, each battery module including a plurality of battery cells, a coolant inlet, and a coolant outlet;
a coolant manifold plate for supplying and return coolant to and from the battery modules, the coolant manifold plate including:
a wall of the battery pack;
a vertical coolant rail;
a plurality of horizontal coolant rails, wherein
the plurality of horizontal rails are parallel with one another and perpendicular to the vertical rail,
the vertical coolant rail supplies coolant to each of the plurality of horizontal coolant rails, and
the manifold plate supports each battery module.

2. The battery pack of claim 1, wherein the manifold plate is configured to supply coolant from the wall of the battery pack, to the vertical coolant rail, to the plurality of horizontal rails, and to the battery modules.

3. The battery pack of claim 2, wherein the wall of the manifold plate comprises a single coolant inlet and a single coolant outlet.

4. The battery pack of claim 1, wherein the plurality of horizontal rails are located within grooves formed in the wall of the battery pack.

5. The battery pack of claim 1, wherein the vertical rail includes a vertical coolant supply conduit and a vertical coolant return conduit.

6. The battery pack of claim 1, wherein the plurality of horizontal rails each include a planar base portion and a tube portion.

7. The battery pack of claim 6, wherein the horizontal rail is generally flush with an interior surface of wall of the battery pack.

8. The battery pack of claim 1, further including a plurality of inserts located between the horizontal coolant rails and rail-receiving grooves of the wall of the battery pack.

9. The battery pack of claim 8, wherein the inserts are formed of one of a foam, silicone, and/or rubber.

10. The battery pack of claim 1, wherein the vertical rail includes a plurality of supply ports and return ports, and the supply ports and return ports are of different sizes.

11. A battery pack comprising:
a plurality of battery modules, each battery module including a plurality of battery cells, a coolant inlet, and a coolant outlet;
a coolant manifold plate for supplying and return coolant to and from the battery modules, the coolant manifold plate including:
a wall of the battery pack having a plurality of rail-receiving grooves;
a vertical coolant rail having a vertical coolant supply conduit and a vertical coolant return conduit;
a plurality of horizontal coolant rails, wherein the plurality of horizontal rails are parallel with one another, perpendicular to the vertical rail and received in the rail-receiving grooves of the wall of the battery pack;
wherein the vertical coolant rail supplies coolant to each of the plurality of horizontal coolant rails.

12. The battery pack of claim 11, wherein the manifold plate is configured to supply coolant from the wall of the battery pack, to the vertical coolant rail, to the plurality of horizontal rails, and to the battery modules.

13. The battery pack of claim 12, wherein the wall of the manifold plate comprises a single coolant inlet and a single coolant outlet.

14. The battery pack of claim 11, wherein the plurality of horizontal rails each include a planar base portion and a tube portion.

15. The battery pack of claim 14, wherein the horizontal rail is generally flush with an interior surface of wall of the battery pack.

16. The battery pack of claim 11, further including a plurality of inserts located between the horizontal coolant rails and rail-receiving grooves of the wall of the battery pack.

17. The battery pack of claim 16, wherein the inserts are formed of one of a foam, silicone, and/or rubber.

18. The battery pack of claim 11, wherein the vertical rail includes a plurality of supply ports and return ports, and the supply ports and return ports are of different sizes.

19. The battery pack of claim 11, wherein the battery pack includes a plurality of rows and columns of battery modules and the wall of the battery pack, the vertical coolant rail, and the horizontal coolant rails are all metal.

20. A battery pack comprising:
a plurality of battery modules arranged in a plurality of rows and columns, each battery module including a cooling plate, a plurality of battery cells, a coolant inlet, and a coolant outlet;
a coolant manifold plate for supplying and return coolant to and from the battery modules, the coolant manifold plate including:
a wall of the battery pack having a plurality of rail-receiving grooves;
a vertical coolant rail having a vertical coolant supply conduit and a vertical coolant return conduit;
a plurality of horizontal coolant rails, wherein the plurality of horizontal rails are parallel with one another, perpendicular to the vertical rail and received in the rail-receiving grooves of the wall of the battery pack; and
a plurality of inserts located between the horizontal coolant rails and rail-receiving grooves of the wall of the battery pack, the inserts are formed of one of a foam, silicone, and/or rubber; and
wherein the vertical coolant rail supplies coolant to each of the plurality of horizontal coolant rails.
